(19) United States
(12) Patent Application Publication
(10) Pub. No.: US 2025/0191500 A1
(43) Pub. Date: Jun. 12, 2025

(54) Methods And Systems For Onboarding Electronic Shelf Labels

(71) Applicant: QUALCOMM Incorporated, San Diego, CA (US)

(72) Inventors: Jie ZHANG, Shanghai (CN); Zaiyong CHEN, Shanghai (CN); Nicolas GRAUBE, Cambridge (GB); Zhuxian GU, Suzhou (CN); Xiuzhuo SHANG, Shanghai (CN); Zhengjinyang JIANG, Shanghai (CN); Yibo ZHAO, Shanghai (CN); Cheng JIANG, Shanghai (CN); Zhaoming YANG, Shanghai (CN)

(21) Appl. No.: 18/851,428

(22) PCT Filed: Apr. 13, 2023
(86) PCT No.: PCT/CN2023/087971

§ 371 Date: Sep. 26, 2024

(51) Int. Cl. G09F 3/20; H04W 52/02

(52) U.S. Cl. CPC G09F 3/208; H04W 52/0229

(57) ABSTRACT

Various aspects include methods for onboarding information in electronic shelf labels (ESLs). In aspects performed by ESLs, such methods may include scanning for a wakeup packet from an access point remote from the ESL before transmitting an ESL advertisement, transmitting the ESL advertisement in response to receiving a wakeup packet that includes information indicating the ESL should transmit the ESL advertisement, and then receiving onboarding messages or a low power mode directive from the access point. In aspects performed by an access point, such methods may include broadcasting a wakeup packet that identifies a select one or more ESLs among the plurality of ESLs to transmit ESL advertisements, receiving one or more ESL advertisements from the identified select one or more advertising ESLs from among the plurality of ESLs, and transmitting an onboarding message to each of the ESLs corresponding to the select one or more ESLs.

### RELATED APPLICATIONS

This application is a 371 National Phase entry of International Application No. PCT/CN2023/087971, filed on Apr. 13, 2023, which claims the benefit of priority from International Patent Application No. PCT/CN2022/095570, filed 27 May 2022, the entire contents of both of which are herein incorporated by reference.

### BACKGROUND

A growing segment of the economy worldwide involves services that require an efficient system of circulation of people and goods in supermarkets, supply stores, warehouses, and the like. Electronic Shelf Labels (ESLs) have been introduced in these types of settings to improve inventory tracking, product mapping, price change rollouts, and the customer experience generally. However, an access point (AP) or central processing system can easily get overwhelmed when a large number of ESLs, which each correspond to different products and have different locations within a facility, communicate simultaneously with the AP. For example, during the initial setup of an ESL system, thousands of ESLs will simultaneously broadcast advertisements to the AP in order to establish a connection therewith (i.e., onboarding). All these ESL trying to get onboarded at the same time will cause severe interference and lower the performance of the AP.

### SUMMARY

Various aspects of the present disclosure include methods, systems, and devices for improving the effectiveness and efficiency of onboarding electronic shelf labels (ESLs). Various aspects may include scanning, by a processor of the ESL, for a wakeup packet from an access point remote from the ESL before transmitting an ESL advertisement, transmitting, by a transmitter of the ESL, the ESL advertisement in response to receiving a first wakeup packet that includes information indicating the ESL should transmit the ESL advertisement, and receiving onboarding messages or a low power mode directive from the access point.

In some aspects, the information indicating the ESL should transmit the ESL advertisement may include an identification associated with a limited number of ESLs. In some aspects the information indicating the ESL should transmit the ESL advertisement may include a value associated with an address field of the ESL. In some aspects the information indicating the ESL should transmit the ESL advertisement may include a value less than or equal to a sum of octets in an address field of the ESL. In some aspects the information indicating the ESL should transmit the ESL advertisement may include a wildcard pattern parameter. In some aspects, the information indicating the ESL should transmit the ESL advertisement may include a matching value associated with a shelf identification associated with the ESL.

In some aspects, transmitting the ESL advertisement may be timed by the ESL in accordance with an advertising interval included in the received wakeup packet. Transmitting the ESL advertisement may be delayed to conform with a scan interval indicated in the received wakeup packet. Some aspects may include ceasing transmission of the ESL advertisement in accordance with an advertisement timeout label included in the received wakeup packet. Some aspects may include entering a low power mode in response to receiving the low power mode directive. Some aspects may include maintaining the low power mode in response to receiving a second wakeup packet including a store identifier that matches a negative store identifier registered from the received low power mode directive.

Various aspects may include a method for onboarding an electronic shelf label (ESL) among a plurality of ESLs performed by a computing device. Various aspects may include broadcasting, by a transmitter of a computing device to an ESL, a wakeup packet, wherein the wakeup packet identifies a select one or more ESLs among the plurality of ESLs to transmit ESL advertisements, receiving, by a processor of the computing device, one or more ESL advertisements from the identified select one or more advertising ESLs from among the plurality of ESLs, and transmitting, by the transmitter of the computing device, an onboarding message to each of the ESLs corresponding to the select one or more ESLs.

Some aspects may include restricting further processing, by the processor of the computing device, of received one or more ESL advertisements to the one or more ESL advertisements received from the identified select one or more ESLs.

In some aspects the broadcasted wakeup packet may include a wakeup field that identifies the select one or more ESLs. In some aspects the broadcasted wakeup packet may include a wakeup field that identifies an address field of the select one or more ESLs. In some aspects the broadcasted wakeup packet may include a wakeup field that includes a value less than or equal to a sum of octets in an address field of the select one or more ESLs. In some aspects the broadcasted wakeup packet may include a wakeup field that includes a wildcard pattern associated with the select one or more ESLs. In some aspects the broadcasted wakeup packet may include a wakeup field that includes at least one shelf identification associated with the select one or more ESLs. In some aspects the broadcasted wake up packet may identify the select one or more ESLs as a subset of ESLs from the plurality of ESLs. In some aspects the broadcasted wakeup packet may indicate temporal restrictions when the select one or more ESLs should transmit the respective ESL advertisements. In some aspects the broadcasted wakeup packet may indicate a scan interval limiting when the select one or more ESLs should transmit the respective ESL advertisements. In some aspects the broadcasted wakeup packet may include more than one distinct wakeup field for identifying the select one or more ESLs.

Further aspects include an ESL and an AP and/or a store management entity server (or other entity) configured with a processor for performing one or more operations of any of the methods summarized above. Further aspects include an ESL having a processor configured to perform one or more operations of any of the methods summarized above. Further aspects include an AP having a processor configured to perform one or more operations of any of the methods summarized above. Further aspects include a store management entity server (or other entity) that includes a processor configured to perform one or more operations of any of the methods summarized above. Further aspects may include a non-transitory processor-readable storage medium having stored thereon processor-executable instructions configured to cause a processor of an ESL or an AP to perform operations of any of the methods summarized above. Further aspects include an ESL or an AP having means for performing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram illustrating an ESL system suitable for implementing any of the various embodiments.

FIG. 1B is a system block diagram illustrating an example configuration of signal communications in an ESL system implementing some embodiments.

FIG. 2 is a component block diagram illustrating an example computing and wireless modem system on a chip suitable for use in a computing device implementing any of the various embodiments.

FIG. 3A is a process flow diagram illustrating phases involved in onboarding an ESL according to various embodiments.

FIG. 3B is a communication flow diagram illustrating a method for onboarding a group of ESLs according to various embodiments.

FIG. 3C is a communication flow diagram illustrating a method for onboarding multiple groups of ESLs according to various embodiments.

FIG. 3D is a communication flow diagram illustrating a method for onboarding multiple groups of ESLs according to various embodiments.

FIG. 4A is a process flow diagram illustrating a method for onboarding an ESL performed by a processor of the ESL in accordance with various embodiments.

FIG. 4B is a process flow diagram illustrating a method for onboarding an ESL performed by a processor of the ESL in accordance with various embodiments.

FIG. 4C is a process flow diagram illustrating a method for onboarding an ESL, including the ESL entering a low power mode, performed by a processor of the ESL in accordance with various embodiments.

FIG. 4D is a process flow diagram illustrating a method for onboarding an ESL performed by a processor of the ESL, including maintaining a low power mode, in accordance with various embodiments.

FIG. 4E is a process flow diagram illustrating a method for onboarding an ESL performed by a processor of the ESL, including entering a dormant mode, in accordance with various embodiments.

FIG. 4F is a process flow diagram illustrating a method for onboarding an ESL performed by a processor of the ESL, including receiving a store identifier override, in accordance with various embodiments.

FIG. 5A is a process flow diagram illustrating a method for onboarding an ESL performed by a processor of an AP in accordance with various embodiments.

FIG. 5B is a process flow diagram illustrating a method for onboarding an ESL performed by a processor of an AP that restricts further processing of ESL advertisements in accordance with various embodiments.

FIG. 5C is a process flow diagram illustrating a method for onboarding an ESL performed by a processor of an AP that broadcasts a store identifier override in accordance with various embodiments.

FIG. 6 is a component block diagram of an ESL suitable for use with various embodiments.

FIG. 7 is a component block diagram of an access point suitable for use with various embodiments.

FIG. 8 is a component block diagram of a server suitable for use with various embodiments.

FIG. 9 is a component block diagram of a user mobile device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and systems implementing the methods, for onboarding a large number of ESLs, such as in a store or warehouse, by an access point (AP) in a manner that enables the AP to accomplish onboarding without overwhelming wireless communication links to the ESLs. Each of numerous ESLs may scan for wakeup packets that are broadcast by an AP before the ESL transmits its ESL advertisement. The ESLs may be initially in a scan-only mode in which each ESL waits to receive one or more wakeup packets indicating when each respective ESL should transmit its ESL advertisement. Thus, each ESL may transmit its ESL advertisement in response receiving one or more wakeup packets, which include information indicating that the ESL should transmit its ESL advertisement. Like the one or more wakeup packets received from the AP, the ESL advertisement may include one or more ESL advertising packets. Thereafter, the ESL may receive onboarding messages from the AP that are responsive to the transmitted ESL advertisement. Various embodiments enable individual APs to control when some or all ESLs start broadcasting the ESL advertisement, rather than allowing all the ESLs to advertise at the same time. In addition, the APs may be given more flexibility to establish different wakeup strategies according to a retailer-specific use case. In this manner, the AP can control which and how many ESLs transmit advertisements to initiate onboarding.

The term “electronic shelf label” or “ESL” is used herein to refer to a computing device with an electronic display that can be placed or secured to, in, on, or near store shelves. The ESL may include a processor, memory, a display, and one or more wireless transceivers, in which the processor may be programmed or provided data to render images (e.g., text, bar codes, trademarks, etc.) that communicate information (e.g., to people) regarding products near the device. In some aspects, ESLs may be battery powered to enable placement on or near products without the need for a power infrastructure. Alternatively, an ESL may be supplied power by the shelve to which the ESL is secured.

ESLs may be programmed, reprogrammed or updated (e.g., via onboarding messages transmitted by the AP) so that product information rendered on the display can be updated at any time. Thus, the ESLs may serve the function of paper shelf labels with the added efficiency of enabling product information (e.g., prices) to be changed without physically replacing shelf labels.

While various embodiments are described with reference to ESLs being placed on shelves within a store, ESLs may also be positioned on large goods (e.g., furniture, appliances, etc.), on or near stands or stacks of goods, on pallets on which products are positioned, and other locations where products may be offered for sale or selection. Further, ESLs may be used for other purposes, such as placed on doors to indicate vacant or occupied status. Thus, the “S” in ESL is not intended to limit the claims to labels that are only positioned on shelves.

In some configurations, ESLs may be extended reality (XR) tags configured to send signals to XR glasses (e.g., smart glasses, display screen of a smart phone, or other device configured to provide extended reality displays) that cause the XR glasses to generate a visible display. The content visible displays generated on XR glasses (and the like) based on signals of the XR tag (e.g., Lays Potato Chips $1.99) may be viewable while a store picker or other user looks at the ESL. The information provided by the XR tags may be the same or different than what is viewable in the ESL to normal users that don't have XR glasses or another XR device. In some embodiments, the ESL may not include a display, but rather operate as an XR anchor to send operation messages and other information to XR devices. For example, when a user wearing XR glasses looks at a product (e.g., Lays Potato Chips), a small window appears on a user interface (UI) showing the product information (e.g., Lays Potato Chips $1.99).

As used herein, the term “computing device” refers to an electronic device equipped with at least a processor, memory, and a device for presenting output such as a location of an object or objects of interest. In some embodiments, a computing device may include wireless communication devices such as a transceiver and antenna configured to communicate with wireless communication networks. A computing device may include any one or all of an outer smart device, a base-band, smart watches, smart rings, smart necklaces, smart glasses, smart contact lenses, contactless sleep tracking devices, smart furniture such as a smart bed or smart sofa, smart exercise equipment, Internet of Things (IoT) devices, augmented/virtual reality devices, cellular telephones, smartphones, portable computing devices, personal or mobile multimedia players, laptop computers, tablet computers, 2-in-1 laptop/table computers, smart books, ultrabooks, multimedia Internet-enabled cellular telephones, entertainment devices (e.g., wireless gaming controllers, music and video players, satellite radios, etc.), and similar electronic devices that include a memory, wireless communication components and a programmable processor. In some embodiments, a computing device may be wearable device by a person. As used herein, the term “smart” in conjunction with a device, refers to a device that includes a processor for automatic operation, for collecting and/or processing of data, and/or may be programmed to perform all or a portion of the operations described with regard to various embodiments.

The term “mobile wireless device” is used herein to refer to computing devices that include any one or all of customer smartphones, a store picker's mobile wireless device, cellular telephones, portable computing devices, laptop computers, tablet computers, smartbooks, ultrabooks, palmtop computers, multimedia Internet-enabled cellular telephones, wearable devices including smart watches, smart clothing, smart glasses, earbuds, headphones, smart wrist bands, and similar electronic devices that include a memory, wireless communication components and a programmable processor.

The term “user mobile device” is used to refer to a mobile wireless device that is specifically configured to support users within a store, such as the store picker job functioning within a store picker system according to various embodiments. A store picker wireless device may include a processor, memory, an electronic display, wireless transceiver(s) including a Bluetooth transceiver and Wi-Fi transceiver, a barcode scanner, and other components useful for store picking.

The term “store” when used herein with reference to a physical place refers to a wholesale, retail, or other building in which products are stored for sale and/or distribution. A store may include (but is not limited to) a warehouse, fulfillment center, department store, specialty store, market, supermarket, hypermarket, convenience store, discount store, super store, and/or other storage facility.

The term “product” is used herein to refer to one or more items, articles, merchandise, or substances that are collected, refined, manufactured, and/or assembled and are maintained in a store or the like, such as products that may be identified on a shopping list and picked by store pickers.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single computing device. The proximity of the SOCs facilitates high speed communications and the sharing of memory and resources.

In overview, various embodiments include methods, and systems implementing the methods for supporting onboarding of a large number of ESLs without overloading the wireless communication capacity of an AP. The process of onboarding ESLs is used to load into the memory of ESLs information regarding the product, price, unit price, and other information that each ESL should display. To onboard ESLs, a first a communication link should be established between each ESL and the AP. To establish each communication link, the AP must receive and process an advertisement, such as following the handshaking protocol of Bluetooth. When there are numerous ESLs configured to communicate with a respective AP, the number of advertisement messages that could be received simultaneously or overlapping in time and in spectrum frequency by an AP could exceed the ability of the AP to receive and process. In accordance with various embodiments, rather than having all the ESLs broadcasting advertisements simultaneously, initially the ESLs may be configured not to wait in a listen only state and not transmit advertisements. Instead, the ESLs listen for (i.e., scan to detect) a wakeup packet sent from the AP, and then use information in the wakeup pack to determine whether to transmit an advertisement message. The wakeup packet from the AP may include a variety of information that indicates when each ESL should transmit its respective advertisements. Such information may be an individual address for a single ESL, information including a plurality of identifiers or a range of addresses, shelf identification (e.g., ShelfID), a class of ESL, a version of software run on ESLs, etc. to trigger advertisement transmissions from a selected subset of the plurality of ESLs. In this way, the transmission by each ESL of an advertisement may be coordinated in a way that will not overwhelm the AP.

By using large-scale deployment of ESLs equipped with wireless transceivers, such systems provide an infra-structure of numerous anchoring points useful for determining the location of products and even the proximity of each user mobile device within the store/warehouse and with respect to particular products. But onboarding a large-scale deployment of ESLs may overwhelm an AP if not regulated in some way. Various embodiments provide tools for onboarding ESLs by using the communication capabilities of the ESLs to assist in the collective deployment of a vast number of ESLs in the store more efficiently. Once the AP brings the ESLs onboard, a management system may determine the locality and relative position of ESLs both within the store and on the shelves or other designated location. In addition, such systems and methods provide the management system information useful in mapping various ESLs to a planogram that may be maintained by a central system or server. Such a planogram may be used to guide store pickers to particular products and/or arrange the distribution of products within the store.

As described in more detail with reference to the figures, various embodiments provide systems that include a store management entity server within a store that is coupled to a plurality of wireless APs (e.g., Wi-Fi, Bluetooth Low Energy (BLE) access points, and/or the like) that are deployed throughout the store/warehouse and configured to establish wireless communication links (e.g., Wi-Fi or BLE) with a large number of ESLs. The ESLs may be configured to transmit and receive BLE messages, such as ESL advertisements that identify and locate the individual ESLs to the AP and/or store management entity server.

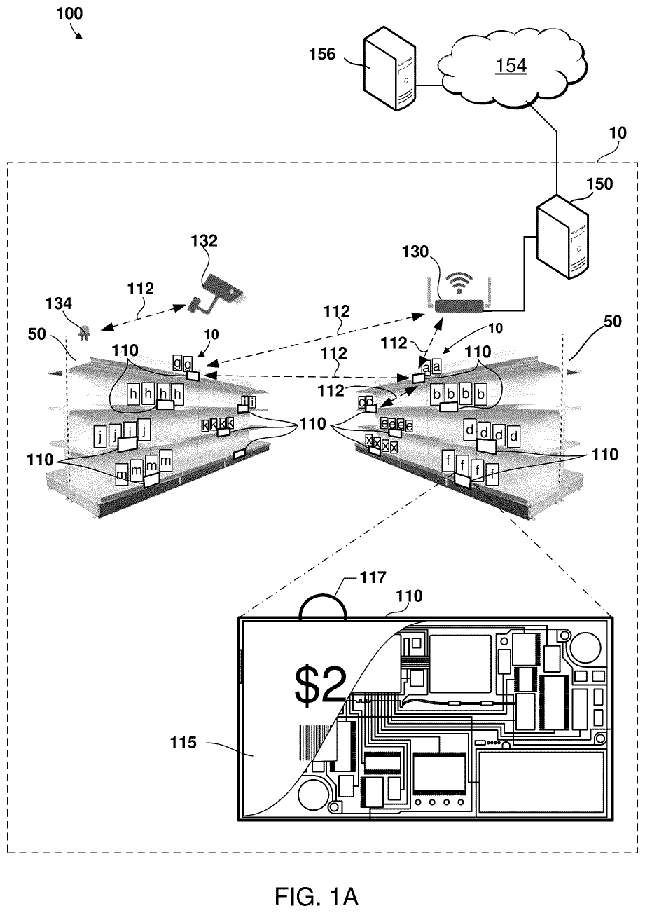

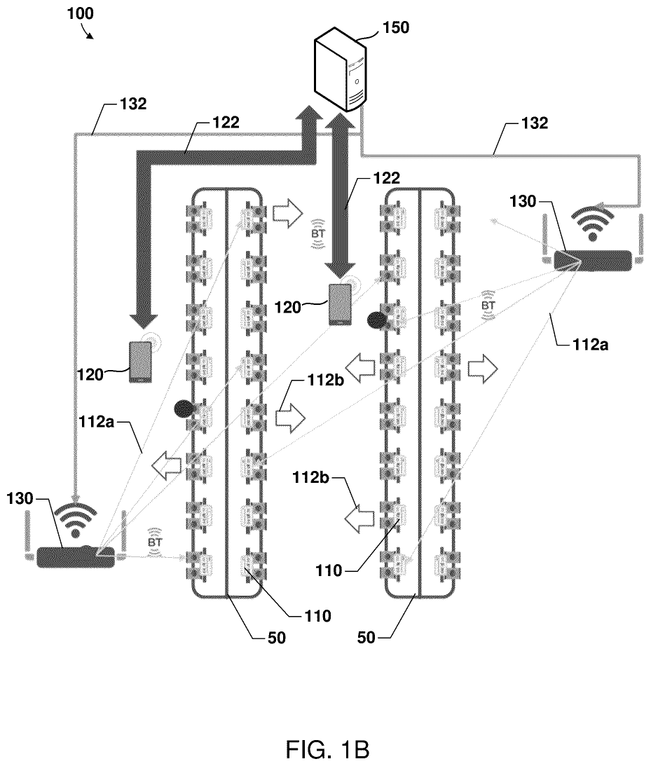

FIG. 1A is a component block diagram of an ESL system 100 suitable for implementing various embodiments. System elements that may be deployed within a given store 10 may include a plurality of ESLs 110 deployed on shelves 50 that are configured to communicate with a number of APs 130 that are connected to a store management entity server 150.

ESLs 110 may be positioned on shelves 50 associated with products (labeled a, b, c, d, e, f, g, h, i, j, k, and m). Each ESL 110 may include a display 115 on which is presented product name, product codes, prices, stocking information, barcodes, and the like. Some ESLs 110 may further include a light emitting diode (LED) 117 or other visible light generating devices configured to illuminate to draw the attention of a store picker and/or other customers as described herein. In some embodiments, some ESLs 110 may include a speaker or vibration-generating device to generate visual, audible, and/or tactile notifications. Each ESL 110 may include a beacon transmitter and be configured to detect neighboring ESLs, such as via BLE signals. Some ESLs 110 may include one or more sensors, such as (but not limited to) a proximity sensor to detect when an individual is standing near the ESL 110, a microphone for monitoring ambient noise as well as receiving speech from a customer or store picker in some embodiments, and/or the like. In some embodiments, not every ESL will be configured and/or equipped the same or with the same capabilities.

The ESLs 110 may be configured to receive communications from the store management entity server 150, such as through wireless links 112 that may be relayed via the APs 130. Thus, the store management entity server 150 may configure each ESL 110 with product information to be displayed, as well as duty cycles for when the ESL should activate to receive signals and transmit wireless beacons. The store management entity server 150 may control the periodicity of ESL duty cycles in order to minimize battery drain/usage, so as to extend the operating life, while ensuring the ESL is responsive to customers and store pickers, such as by increasing the duty cycle when individuals are within proximity of an ESL (e.g., close enough to see and/or read a display of the ESL). Further, management entity server 150 may configure ESLs 110 to generate an appropriate indication (e.g., visual, audible, and/or tactile indications) at an appropriate time, such as when an ESL is associated with a product that appears on a shopping list of a user that is nearby (e.g., within a predetermined distance). In various embodiments, the store management entity server 150 may be located within or near the store, or located remotely, such as in the Cloud, and accessed via a network, such as the Internet.

ESLs 110 may be configured to exchange wireless communications with each other through wireless links 112, such as wireless beacons or tones, for various purposes, including in particular for determining the relative and actual location of the ESLs on shelves 50 and with respect to one another as described herein.

In some embodiments, the ESL system 100 deployed within a store 10 may also include other mechanisms for determining the precise location of ESLs and individual store pickers or customers. For example, in some embodiments, the system may include ultrasonic emitters 134 that may be configured to periodically or episodically admit ultrasonic tones (for example) that can be received by a microphone on each ESL 110 for purposes of determining relative location of each ESL via sound ranging processes. As another example, in some embodiment, the system may include infrared emitters that may be configured to emit an infrared light beam that can be received by a photo-detector on each ESL for the purpose of determining relative location via IR ranging techniques. As another example, the system may include cameras 132 coupled to the store management entity server 150 that may be positioned to provide imaging of ESLs 110 as well as individuals (e.g., store pickers, customers, and/or other individuals). Image data received from such cameras 132 may be used by the store management entity server 154 to determining the location of each ESL and individuals. In some embodiments, the camera 132 may be positioned on the shelves so as to view products as well as individuals near the products. In some embodiments, ESLs 110 may include a camera and be configured to transmit images to the store management entity server 150 via a wireless link 112 with an AP 130.

The store management entity server 150 may be configured with detailed maps of the locations of products within the store, referred to as a planogram, that is correlated or calibrated to an indoor location system, such as supported by the ESLs 110 as described. The store management entity server 150 may also incorporate information from an inventory system that keeps track of the products stocks in order to avoid sending a store picker to the location of a product that is out of stock.

The APs 130 may be configured to communicate with ESLs 110 to provide communications with the store management entity server 150. In some embodiments, APs may be configured with cameras or be coupled to cameras to provide visual images of ESLs as well as customers and store pickers to provide more precise location information as described herein. APs 130 may also be configured with antenna arrays that enable determining the angle of arrival (AOA) of wireless communications, providing further localization information to the store management entity server 150.

The user mobile devices 120 may be any form of mobile device, not just the smart phone as illustrated. For example, in addition to being personal mobile devices, the mobile devices 120 that may be used in the system 100 may include smart watches, body cams, augmented reality glasses (e.g., smart glasses), and facility-specific or enterprise-specific handheld devices that are configured specifically for store pickers.

FIG. 1B illustrates further details of the communication links that may be utilized in the ESL system 100 according to some embodiments. With reference to FIGS. 1A and 1B, ESLs 110 may be configured to communicate with APs 130 via wireless links 112a, such as Bluetooth, and to exchange wireless signals with other ESLs 110 via wireless links 112b. For example, ESLs 110 may transmit certain BLE signals 112a, such ESL advertisements that are configured to be received by a nearby AP 130 and used to onboard the ESL 110. In addition, ESLs 110 on opposite sides of an aisle (i.e., the separation between two shelves 50) may transmit certain BLE signals 112b that are configured to be received by a nearby ESL 110 and used for the purposes of determining relative positions of the respective devices. BLE signals 112a, 112b may be broadcast at a set or select power level, enabling separation distances to be estimated based upon the measured received signal strength indicator (RSSI) of the signals received by other ESLs 110. APs 130 may be coupled to the store management entity server 150 via wired connections 132.

User mobile devices 120, which may be held, carried, or otherwise associated with a store picker or customer may receive a beacon signal, such as through a wireless link from ESLs and communicate with the store management entity server 150 via wireless communications, such as BLE, Wi-Fi, or cellular communications of various types. The APs 130 may be configured to communicate with user mobile devices 120 to provide communications with the store management entity server 150. The APs 130 may also provide user mobile devices 120 with access to external networks, such as the Internet 154 to enable customers to access remote servers 156, such as to comparison shop, research products, and otherwise provide Internet access support.

User mobile devices 120 used by store pickers may receive beacon signals (e.g., BT or BLE) from each of the ESLs 110 but also communicate received beacon information (e.g., identity code and RSS I information) directly to the store management entity server 150 via separate communications 122. Such separate communications 122 may be via Wi-Fi communications (e.g., via APs 130) or via cellular data networks (e.g., fifth generation (5G) cellular networks).

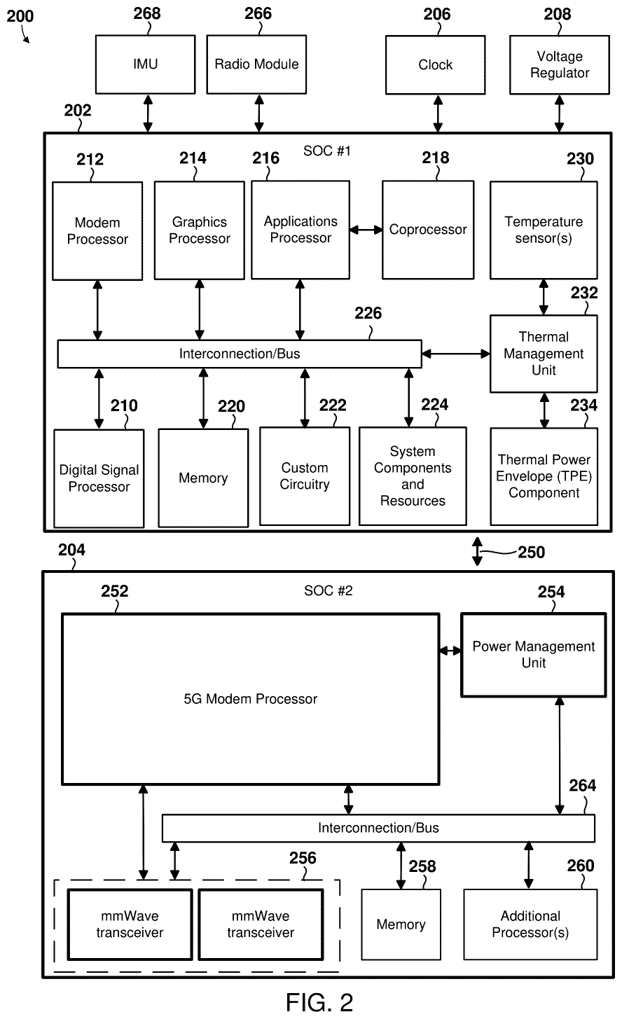

FIG. 2 is a component block diagram illustrating a non-limiting example of a computing and wireless modem system 200 in a computing device suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, a radio module 266 configured to send and receive wireless communications, including BLE messages, via an antenna (not shown and an inertial measurement unit) (IMU) 268. When the computing system 200 is used in ESLs, the radio module 266 may be configured to broadcast BLE beacons as described herein. In some implementations, the first SOC 202 may operate as central processing unit (CPU) of the user mobile device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wavelength (such as 38 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a user mobile device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, 252, 260, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

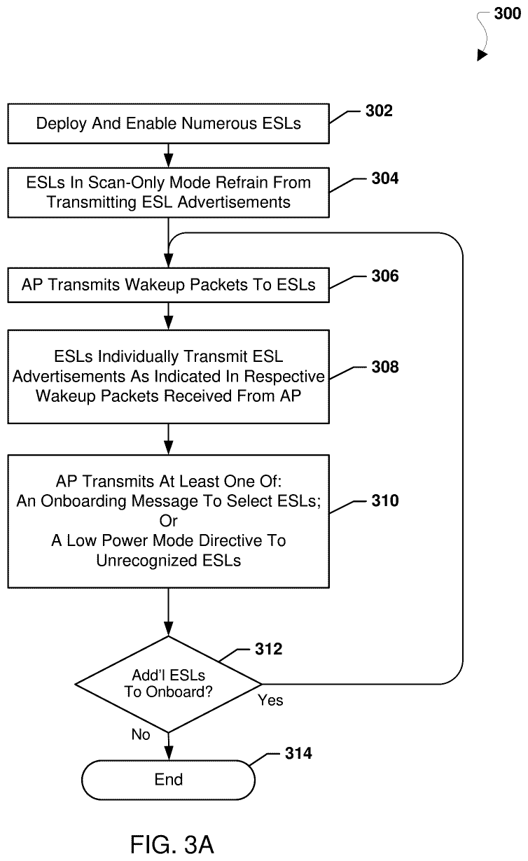

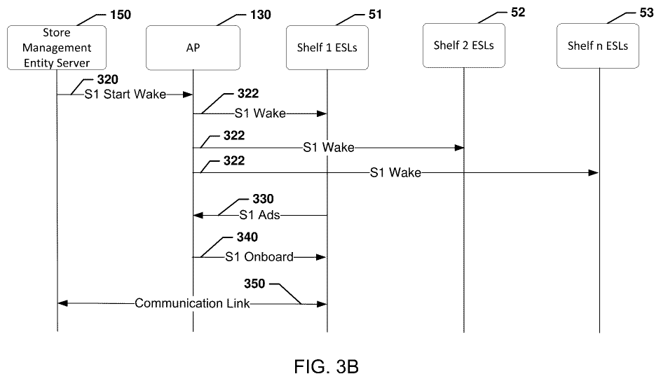

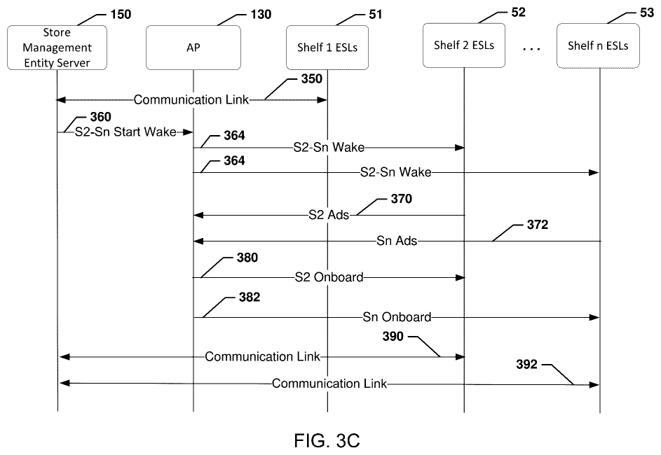

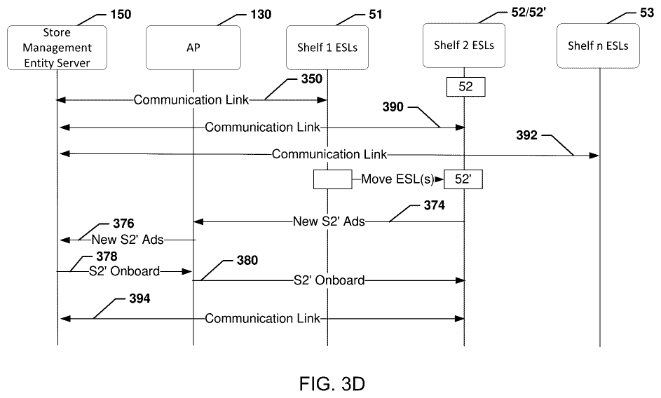

FIG. 3A illustrates an overall method 300 of the various phases involved in deploying and onboarding ESLs as blocks in a process flow diagram, according to various embodiments. With reference to FIGS. 1A-3A, initially in block 302, numerous ESLs (e.g., 110) may be deployed and enabled on shelves (e.g., 50) within a store. As part of deploying the ESLs, products (e.g., a, b, c, d, e, f, g, h, i, j, k, and m) may be placed on the shelves and individual ESLs may be positioned on respective shelves, near a particular product, and associated with that product. In this process, an individual ESL may be associated with a particular product by a stocker or other installer associating a product with the ESL (e.g., reading a QR-Code or bar code on a screen or case of the ESL and reading a QR-Code or bar code on the product). The ESL/product association may be saved in a register of the ESL as a product association value. That product association value may be later included in an ESL advertisement transmitted by the ESL when appropriate. In this way, product information may be communicated later to the store management entity server, such as via an access point, for planogram reconciliation. As part of enabling the ESLs, the stocker or other installer may activate the ESL. Numerous ESLs may be activated at the same time in accordance with various embodiments. For example, all the ESLs on the same shelf, the same rack of shelves, the same isle, or other grouping may be activated at the same time. The activation may at least involve placing the ESLs in a scan-only mode, which may be part of powering-on the ESLs are taking them out of a different mode (e.g., a low-power product association mode in which the ESL is not actively scanning for wakeup packets).

In block 304, after being activated the ESL may start scanning for a wakeup packet in a scan-only mode. In the scan-only mode, the ESLs refrain from transmitting ESL advertisements until instructed otherwise. For example, an ESL will not transmit an ESL advertisement until after receiving a wakeup packet that includes an indication to start transmitting ESL advertisements. Thus, the ESLs may be configured so they initially only listen in a scan-only mode for wakeup packets that may be transmitted by an AP. The ESLs may avoid or may be prevented from transmitting advertising packets while in the scan-only mode. In this way, the ESL may be placed in a type of listen-before-talk configuration. In the scan-only mode, the ESLs may scan for wakeup packets in designated intervals, and may use a predetermined frequency and/or channel (e.g., advertising channels 37/38/39). Such intervals, frequency, and/or channel may be preconfigured in the ESLs.

In block 306, the AP may transmit wakeup packets to the ESLs. The wakeup packets may include indications as to when particular ESLs or groups of ESLs should transmit ESL advertisements. The AP or a store management entity server (or other entity) may devise an onboarding strategy that makes ESLs or groups of ESLs sequentially transmit ESL advertisements so that the AP will limit the number of advertising packets being received during a given period. The wakeup packets may include a wakeup match field intended for only a limited number of ESLs. The AP may indicate which ESL(s) should transmit ESL advertisements (and when) by using a wakeup match field in the wakeup packet. The wakeup match field may be configured to use ESL addresses (e.g., BD_ADDR*), group identifications (e.g., GroupID), shelf identifications (e.g., ShelfID), type identifications (e.g., TypeID, which may indicate a category or type of ESL), and/or other distinguishing forms of identification. The wakeup match field may be written into the wakeup packets with a predetermined format. In some embodiments, the wakeup packet may include more than one distinct wakeup field for identifying select ESLs. For example, the wakeup packet may include a ShelfID and a TypeID in order to target the wake up of ESLs on a particular shelf and of a particular type (e.g., a type or model of ESL, or a type or category of product associated with the ESL). In addition, the wakeup packet may include additional parameters for the ESLs to use when transmitting ESL advertisements, such as indications to transmit at a designated time and/or interval and/or use a predetermined frequency and/or channel (e.g., advertising channels 37/38/39).

In block 308, once any of the ESLs receive a wakeup packet, a processor of that ESL may compare a received value in the wakeup match field(s) of that wakeup packet to one or more stored values for that individual ESL. In response to the comparison yielding a match for any individual ESL, that ESL may start transmitting ESL advertisements (e.g., a Connectable Advertising Packet (CAP)) to the AP, which is a form of BLE advertising report. Alternatively, all ESLs may automatically respond to a received wakeup packet by transmitting an ESL advertisement. Either way, ESLs may exchange ESL advertisements (e.g., via wireless links 112) that may be individually processed by the AP in order to determine the location of each ESL and/or whether each ESL is a recognized ESL (e.g., recognized based on matching BD_ADDR).

Once the ESLs receive a wakeup packet, each may time the delivery of its respective advertisement packet based on information contained within the received wakeup packet. Such information contained within the received wakeup packet may tell individual ESL whether, when, and/or how long to advertise. In this way, the wakeup packet may include timing information for when or if the ESL is supposed to advertise. The wakeup packet may include different wakeup and/or timing information for different ESLs or different groups of ESLs, but individual ESLs may determine which wakeup and/or timing information is appropriate to them based on their own address or other identifier matching corresponding instructions contained within the wakeup packet. In addition to indicating when ESLs should transmit advertisements, the wakeup packet may indicate the frequency and/or duration that the ESLs should advertise. (e.g., random back-off timers, etc.).

In some embodiments, a custom ID field may be included in the wakeup packet. For example, the custom ID field may be a segmented data structure configured such that later segments of the data structure identify one or more subsets of the ESL identified by the earlier segments of the data structure. For example, group ID, shelf ID, a unique ID (concatenated address) may be used in the custom ID field. Using a shelf ID has a unique advantage of informing the AP or confirming on which shelf the ESL is located. Alternatively, separate fields may be included in the wakeup packet, such that BD_ADDR, Shelf ID, Group ID, and/or Unique Shelf ID are separate fields.

In block 310, the AP may transmit at least one of an onboarding message to select ESLs or a low power mode directive to ESLs not recognized by the ME or the AP itself. Thus, while transmitting wakeup packets (e.g., block 306) the AP may be scanning for ESL advertisements from the ESLs. In response to receiving the ESL advertisement, the AP may establish a communication link with the ESLs transmitting advertisements for selectively either onboarding or placing ESLs in low power mode. The transmitted onboarding messages may configure the ESLs and establish a bi-directional communication link between the AP and the ESLs that receive an onboarding message. Otherwise, in response to receiving the low power mode directive, the ESL may enter a low power mode (e.g., for a predetermined duration or number of cycles). In this way, ESLs that are not supposed to be onboarded by the AP may conserve power (e.g., in a camping mode).

In determination block 312, the AP may determine whether additional ESLs still need to be onboarded. In response to determining that one or more additional ESLs still need to be onboarded (e.g., determination block 312=“Yes”), the AP may transmit wakeup packets to the remaining ESLs or a subset of those ESLs. In response to determining that no more additional ESLs still need to be onboarded (e.g., determination block 312=“No”), the AP may terminate (i.e., “End”) the onboarding process in block 314.

FIG. 3B is a communication flow diagram illustrating the communications between various components of the ESL system (e.g., 100) of a given store (e.g., 10) in accordance with various embodiments. In particular, communications are illustrated between the store management entity server 150, the AP 130, and the ESLs on shelf 1, shelf 2, and all the way to shelf n (i.e., the last group of shelves being considered). As part of setting up the ESL system, the various ESL may be placed on the respective shelves 1, 2, . . . n, and activated into scan-only mode.

Initially, the store management entity server 150 may initiate the wakeup of ESLs by transmitting a server start wake message 320 (i.e., S1 Start Wake) to an AP 130. The server start wake message 320 may instruct the AP 130 to start sending wakeup packets. In some embodiments, the server start wake message 320 may be intended for a select set of ESLs. The start wake message 320 may cause the AP 130 to determine and implement a schedule for ESLs to send advertisements, and may include scheduling parameters for the ESLs to start transmitting advertisements, or a combination thereof. In the illustrated example, only the ESLs on Shelf 1 are being onboarded, in accordance with various embodiments. The store management entity server 150 may control more than one AP, in which case additional wake messages may be transmitted to one or more of the additional APs to start onboarding ESLs associated with those APs.

Upon receipt of the server start wake message 320, the AP 130 may broadcast an AP wake message 322 (i.e., S1 Wake). For example, the AP wake message 322 may be broadcast to at least the ESLs on shelf 1. The AP wake message 322 may include one or more wakeup packets for the target ESLs. Alternatively, the server start wake message 320 may be a general broadcast configured to be received by any ESL scanning for a wakeup packet. As a further alternative, or additionally, the AP 130 may initiate the transmission of the AP wake message 322 without being directly instructed to do so by the store management entity server 150. In accordance with various embodiments, since the AP wake message 322 may include indications as to which ESLs the message is intended, the ESLs on the other shelves (e.g., Shelf 2 to Shelf n) may also receive the broadcast of the AP wake messages 322 (i.e., S1 Wake). However, only the appropriate ESLs, such as the first shelf ESLs 51 should respond by transmitting ESL advertisements.

After determining that the AP wake message 322 was intended for the ESLs 51 on Shelf 1, those ESLs 51 may start transmitting ESL advertisements 330 to the AP 130. The ESLs 52, 53 will not start transmitting ESL advertisements, if the AP wake message 322 included an indication that it was not intended for them. In this way, the other ESLs 52, 53 will remain in the scan-only mode, continuing to wait for a wakeup packet intended to activate them. Alternatively, all ESLs may be configured to start transmitting ESL advertisements 330 immediately upon receipt of any AP wake message 322.

Upon receipt and detection of the ESL advertisement 330 from the first shelf ESLs 51, the AP 130 may transmit onboarding messages 340 (i.e., S1 Onboard) to the first shelf ESLs 51. The onboarding messages 340 may bring the first shelf ESLs 51 online, thus providing a communication link 350 between the first shelf ESLs 51, the AP 130, and the store management entity server 150. Once the first shelf ESLs 51 are onboarded, the store management entity server 150 and/or the AP 130 may start waking other ESLs (e.g., 52, 53).

FIG. 3C is a communication flow diagram illustrating the communications between various components of the ESL system (e.g., 100) of a given store (e.g., 10) in accordance with various embodiments. In particular, further communications are illustrated between the store management entity server 150, the AP 130, and the ESLs after establishing the communication link 350 with the first shelf ESLs 51 (see FIG. 3B).

Initially, the store management entity server 150 may initiate the wakeup of multiple groups of ESLs (e.g., the remaining ESLs 52, 53) by transmitting a server start wake message 360 (i.e., S2-Sn Start Wake) to an AP 130. The server start wake message 360 may be similar to the server start wake message 320 that was sent earlier to the first shelf ESLs 51, only now intended for different ESLs (e.g., shelf 2 ESLs to shelf n ESLs). In the illustrated example, the remaining ESLs from Shelf 2 to Shelf n are being onboarded, in accordance with various embodiments. The store management entity server 150 may control more than one AP, in which case additional wake messages may be transmitted to one or more of the additional APs to start onboarding ESLs associated with those APs.

Upon receipt of the server start wake message 360, the AP 130 may transmit AP wake message 364 (i.e., S2-Sn Wake) to the remaining ESLs 52, 53. The AP wake message 364 may include one or more wakeup packets for the target ESLs. Alternatively, the AP 130 may initiate the transmission of the AP wake message 364 without being directly instructed to do so by the store management entity server 150. In accordance with various embodiments, since the AP wake message 364 includes indications as to which ESLs the message is intended (e.g., shelf 2 ESLs to shelf n ESLs), the first shelf ESLs 51, which already have an established communication line 350 may receive but ignore the AP wake message 364. Thus, only the remaining ESLs 52, 53 should respond by transmitting ESL advertisements in accordance with the AP wake message 364.

After determining that the AP wake message 364 was intended for the remaining ESLs 52, 53, those ESLs 52, 53 may start transmitting ESL advertisements 370, 372 to the AP 130. The first shelf ESLs 51 already have the established communication line 350 and thus will not start transmitting ESL advertisements.

Upon receipt and detection of the ESL advertisements 370, 372 from the remaining ESLs 52, 53, the AP 130 may transmit onboarding messages 380, 382 (i.e., S2 Onboard and S) to the remaining ESLs 52, 53. The onboarding messages 380, 382 may bring the remaining ESLs 52, 53 online, thus providing communication links 390, 392 between the remaining shelf ESLs 52, 53, the AP 130, and the store management entity server 150. Once the remaining shelf ESLs 52, 53 are onboarded, the store management entity server 150 and/or the AP 130 may start waking any other necessary ESLs.

FIG. 3D is a communication flow diagram illustrating the communications between various components of the ESL system (e.g., 100) of a given store (e.g., 10) in accordance with various embodiments. In particular, further communications are illustrated demonstrating how the store management entity server 150, the AP 130, and the ESLs 51, 52, 53 may update location information of individual ESLs even after one or more ESLs are moved.

In the illustrated example, all the ESLs 51, 52, 53 have already been onboarded and have established communication links 350, 390, 392. Subsequently, some of the first shelf ESLs 51 are moved to the second shelf 52. After some of the first shelf ESLs 51 are moved to the second shelf, a store stocker or other installer that moved the first shelf ESL 51 may reactivate the moved first shelf ESL(s), which may now be considered a new second shelf ESL 52′. In some embodiments, a reactivation protocol may vary from an initial activation protocol because numerous ESLs may not need to be reactivated simultaneously. The reactivation protocol may place the new second shelf ESL 52′ in an advertising mode. In this way, the new second shelf ESL 52′ may start transmitting New ESL advertisements 374 (i.e., New S2′ Ads) to the AP 130.

Upon receipt and detection of the New ESL advertisements 374 from the new second shelf ESL 52′, the AP 130 may detect that the new second shelf ESL 52′ has been moved and thus transmit the New ESL advertisement 376 to the store management entity server 150 for updating the central database. The store management entity server 150 may acknowledge receipt of the New ESL advertisement 376 and respond by sending the AP 130 on onboarding message 378 (i.e., S2′ Onboard) directing the AP 130 to onboard the new second shelf ESL 52′. Accordingly, the AP 130 may transmit an onboarding messages 380 (i.e., S2′ Onboard) to the new second shelf ESLs 52′ and thus establish a new communication link 394 to the new second shelf ESLs 52′ and maintain a communication link with the existing second shelf ESLs 52.

Alternatively, the reactivation protocol may be similar to the initial activation protocol that starts the new second shelf ESL 52′ in a scan-only mode. In this scenario, the AP 130 and/or the store management entity server 150 may be responsible for detecting that the new second shelf ESL 52′ is no longer in its previous location and thus the AP 130 may transmit a wakeup packet to the new second shelf ESL 52′ to establish a communication link similar to the way the initial communication link was established.

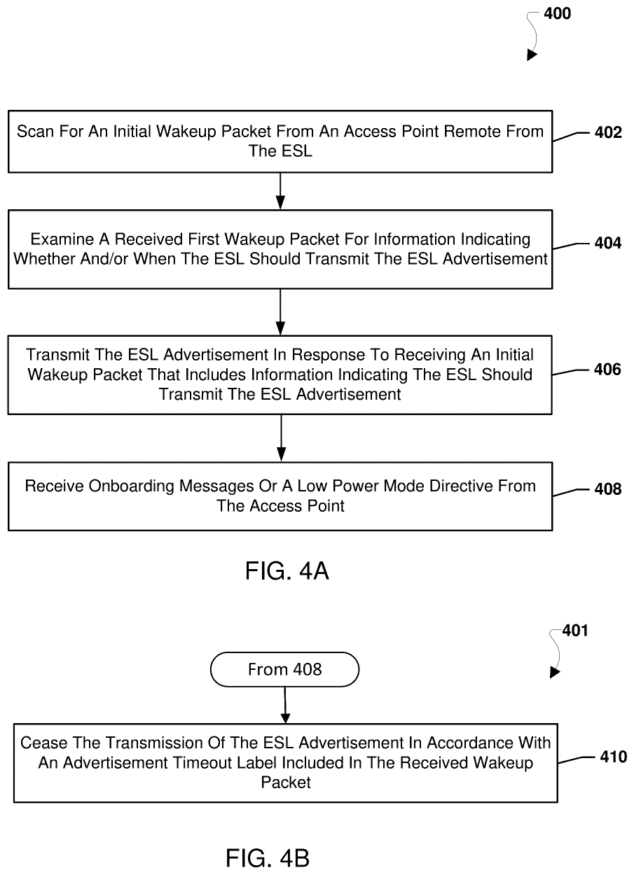

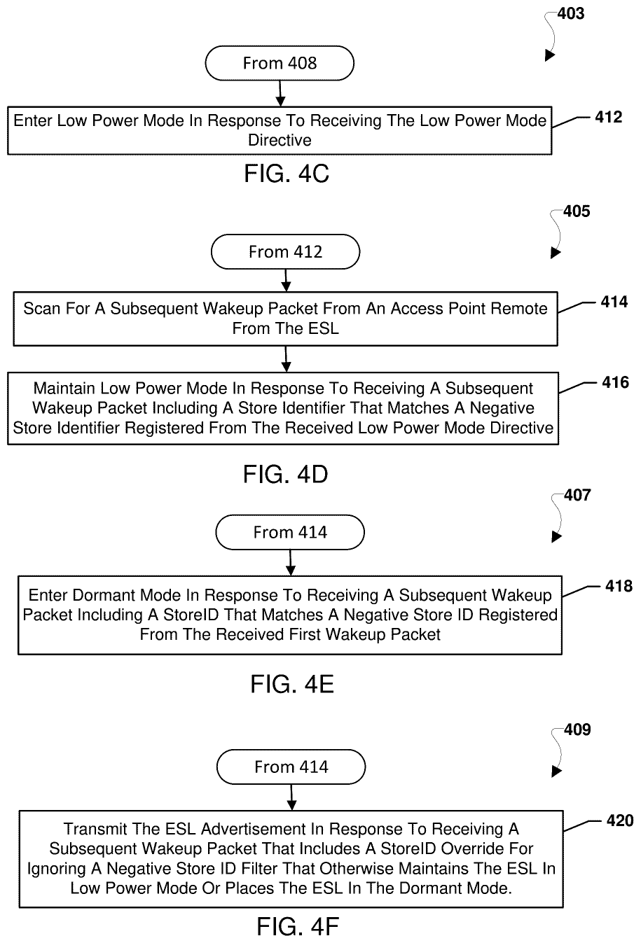

FIG. 4A is a process flow diagram illustrating a method 400 for onboarding an ESL performed by a processor and/or a transceiver of an ESL, in accordance with various embodiments. With reference to FIGS. 1A-4A, means for performing each of the operations of the method 400 may include a processor (e.g., 210, 212, 214, 216, 218, 252, 260, and/or 602) and/or a transceiver (e.g., 604) of an ESL (e.g., 110) and the like.

In block 402, a processor of the ESL may scan for a wakeup packet from an AP (e.g., 130) remote from the ESL before transmitting an ESL advertisement. The ESL may begin scanning after being activated, such as after being powered-on or after being woken from a dormant state. In various embodiments, the ESLs are configured to automatically enter a scan-only mode after being powered-on or waking from a dormant state. In this way, the ESL does not immediately transmit ESL advertisements to the AP. Configuring numerous or all ESLs to automatically enter the scan-only mode may prevent the AP from getting overwhelmed and/or from the numerous ESLs generating to much signal interference by simultaneously advertising, which may degrade AP performance. In the scan-only mode the ESL may wait to be onboarded, which may be triggered by receipt of a wakeup packet.

In response to receiving the wakeup packet from the AP, in block 404 the processor of the ESL may examine the wakeup packet to obtained included information indicating whether and/or when the ESL should transmit the ESL advertisement. This information indicating whether the ESL should start transmitting ESL advertisements may be included in a wakeup match field of the wakeup packet. The information in the wakeup packet (or particularly the wakeup match field) may include an identification associated with a limited number of ESLs (i.e., one or more specific ESLs). For example, the identification associated with an ESL, indicating that ESL should transmit the ESL advertisement, may include a value associated with an address field of the ESL. Each ESL may have a unique BD_ADDR value used for BLE communication. If the information in the wakeup packet matches all or part of the address (i.e., the BD_ADDR value) of the ESL, then the ESL may respond accordingly by transmitting the ESL advertisement.

Alternatively, or additionally, another value specifically associated with one or more ESLs to the exclusion of other ESLs may be used as the identification for that/those one or more ESLs to start advertising. In some embodiments, the information in the wakeup packet, indicating the ESL should transmit the ESL advertisement, may include a range of values, which may be used to notify a range of ESL's to enter an advertising mode. For example, the range of values may indicate a value less than or equal to a sum of octets in an address field of the ESL. By designating a range of addresses, the ESL may assign groups of ESLs to advertise together. The size of such groups may be designed to ensure their simultaneous advertisements will not cause interference or too much interference and/or ensure proper performance of the AP. In some embodiments, the information indicating the ESL should transmit the ESL advertisement may include a wildcard pattern parameter, like “AA:BB:CC:DD:*.*.” Such a wildcard pattern parameter may be used to notify a subset of ESLs to wake up and start advertising. In some embodiments, the information indicating the ESL should transmit the ESL advertisement may include a matching value associated with a shelf or group identification associated with the ESL. By identifying a particular shelf or group, the AP by direct select groups of ESLs to start advertising.

In some embodiments, an advertising interval may be included in the received wakeup packet that the ESL process may use to time the transmission of the ESL advertisement by the ESL. For example, the wakeup packet from the AP may indicate a particular schedule (e.g., an advertising schedule) as to when the ESL advertisements should be transmitted. The advertising schedule may indicate when to start and stop advertising, as may even indicate the frequency with which advertisements should be transmitted. In this way, the advertising schedule may indicate almost any time-based advertising method. The advertising interval and/or schedule may be indicated in a field of the wakeup packet (e.g., an advertising interval or advertising schedule field). In some embodiments, transmitting the ESL advertisement may be delayed, after initial receipt of the wakeup pack, to conform with a scan interval indicated in the received wakeup packet.

Some embodiments include creating a schedule for ESLs to transmit ESL advertisements, which may carry a unique code and identity. The unique code and identity may be known to the store management entity server, APs, or other entity and may be mapped to the location of the ESL. To provide security against spoofing and non-authorized usage of the ESL advertisements by other parties/applications, as well as provide confidentiality for the contents of advertising packets and the address of the source of the transmission (e.g., the ESL), the unique code, as well as encryption keys used to encrypt the advertising packet can be protected by periodically rotating (i.e., time-varying) the unique code and advertisement encryption key. The identity of the ESL and the contents of the packet may be determined in the store management entity server, APs, or other entity with knowledge of the rotation algorithm for processing. When the store management entity server, APs, or other entity detects an ESL advertisement, the store management entity server, APs, or other entity may estimate the ESL's location.

In block 406, the transceiver of the ESL, which includes a transmitter, may transmit the ESL advertisement in response to receiving a first wakeup packet that includes information indicating the ESL should transmit the ESL advertisement. The ESL may transmit an ESL advertisement that includes information about the ESL at times and in accordance with information included in the wakeup packet received from the access point. To transmit the ESL advertisement the ESL may switch from the scan-only mode to an advertising mode. In the advertising mode the ESL broadcasts an ESL advertisement to let the AP discover and onboard the ESL.

The ESL advertisements may include various types of information about the ESL, the associated product, and even the location within the store at which the ESL is located. Various embodiments include tools that facilitate dense deployment of ESLs and products within facility shelving, aisles, and sections of the store by supporting automatic determination of the location of many ESLs within a store. Such embodiments may include determining a location of a select subset of ESLs within a store. The location information provided to the store management entity server, APs, or other entity from the ESLs may be supplemented from received signal strength indicator (RSSI) measurements between ESLs and APs to create approximately co-located sub-groups. Additionally, measurements may be taken by ESLs in each sub-group using angle of arrival (AOA), high-accuracy-distance-measurements, ultrasonic ranging techniques, infrared ranging techniques, ultra-wideband (UWB) or RSSI to determine multiple range and/or angle measurements between subgroup ESLs from which the relative location of ESLs (and thus associated products) within each sub-group may be determined. In some embodiments, anchor points in each sub-group may be identified to enable each ESLs absolute location to be determined. Similarly, the location of one or more products to many ESLs in relation may be determined by using the coarse proximity measurements of each ESL towards each of its immediate neighbor, and then mapping a planogram representing physical placements of products in known aisles, sections, and shelfs to the ESL location. The association of few ESL with products may facilitate the entire reconciliation of the ESLs neighboring map against the planogram. This may further allow for all remaining ESLs to be associated with particular products.

In block 408, the transceiver of the ESL may receive one or more onboarding messages or a low power mode directive from the AP. The onboarding messages may be received from the AP in response to the AP receiving the transmitted ESL advertisement. The onboarding messages may provide the ESL information that may be used for establishing a connection with the AP. For example, a store in which numerous ESLs are located may have many APs, but the onboarding message may direct the ESL to communicate with one particular AP that is identified in the onboarding message. As part of block 408, the ESL process may store onboarding information (e.g., product description, price, unit price, etc.) in memory and begin displaying the information. In contrast, although the low power mode directive may establish a communication link between the ESLs receiving it and the AP, the low power mode directive may also be configured to cause the ESL to go into a low power mode, such as a camping mode. In response to receiving the low power mode directive, the ESL may be configured to enter into the low power mode for a predetermined duration. Alternatively, in response to receiving the low power mode directive, the ESL may be configured to enter into the low power mode for a predetermined number of cycles (e.g., 10 cycles). As a further alternative, the ESL may enter a low-latency (i.e., dormant) mode, which is a deeper low power mode.

FIG. 4B is a process flow diagram illustrating a method 401 for onboarding an ESL performed by a processor and/or a transceiver of an ESL, in accordance with various embodiments. With reference to FIGS. 1A-4B, means for performing each of the operations of the method 400 may be performed by a processor (e.g., 210, 212, 214, 216, 218, 252, 260, and 602) and/or a transceiver (e.g., 604) of an ESL (e.g., 110) and the like.

In block 410, following the operations in block 406 of the method 400, the transceiver (e.g., 604) of the ESL (e.g., 110) may cease the transmission of the ESL advertisements in accordance with an advertisement timeout label included in the received wakeup packet. The advertisement timeout label may prevent an ESL from transmitting advertisements indefinitely. This capability may be useful in case something happened to the designated AP and/or the ESL never receives an onboarding message. Each ESL may have a default advertisement timeout label and/or the value for the advertisement timeout label may be provided in the wakeup packet.

In various embodiments, techniques may be employed that avoid one or more ESL's being improperly onboarded by a non-designated AP and/or an unintended ME. For example, when one or more ESL's are in transit and/or are moved into close proximity with a facility that includes an unintended AP transmitting a wakeup packet, various embodiments may provide an enhancement that accounts for such an event. This may occur when ESL's are moved into a facility, complex, or commercial center that has multiple stores in close proximity to one another, thus placing ESL's within range of an AP from a neighboring store. Alternatively, when being relocated, ESL's may be moved into close proximity with an unintended AP (and an associated unintended ME). ESL's are not generally provided with filters or specific store identifiers ahead of time, since it is burdensome for manufacturers to pre-allocate such things (e.g., the manufacturer may not know where a particular ESL may end up). Thus, various embodiments may enable an ME and/or ESL to recognize such situations and in response place the ESL in a low power mode to conserve battery and not get improperly onboarded by an unintended or non-designated ME.

Various embodiments may leverage the fact that stores/retailers (i.e., each ME) are usually provided with an inventory of expected ESL's. Such inventories include identifying information for such expected ESL's (e.g., BD_ADDR), which are needed for Public/Private Key communications and thus needed for an ME to onboard an ESL. In accordance with various embodiments, when an ME receives a CAP from an unrecognized ESL (e.g., including an unrecognized BD_ADDR), the ME may direct any unrecognized ESL into a lower power mode (e.g., camping mode), which communication may not require any security or special communications protocols. In addition, at the same time the ME may inform any unrecognized ESL that the store (i.e., the ME) issuing the wakeup packet it received is not its intended store (e.g., a negative store ID). The ESL's receiving a negative store ID may save this information in order to avoid responding to WAP's received from that store in the future or at least for a predetermined period. This may avoid the power consumption associated with entering an advertising mode and possibly save power by having an ESL enter a deep sleep mode for a period of time.

Occasionally, ESLs may be delivered to a store and deployed before the ME has updated the registry used to identify those ESLs. In this circumstance, the ESLs will not be recognized by the ME and the ESLs may place the local AP on the negative store identifier registry. Thus, if that local AP subsequently transmits second wakeup packets, the wakeup packets will be ignored since the store identifier for that AP will match the one in the negative store identifier registry. Accordingly, various embodiments may overcome this issue by including a store identifier override in the second wakeup packet. The store identifier override may be configured to enable the ESL to ignore the negative store ID filter that would otherwise maintain the ESL in a low power mode or place the ESL in the dormant mode. In response to receiving a wakeup packet, the ESLs may scan the wakeup packet to determine whether it includes the store identifier override. The store identifier override may be used to force all ESL's receiving the wakeup packet to go into advertising mode (i.e., come out of camping). This allows the ME to make sure no ESL's ignore its messages.

Alternatively, some embodiments may overcome the negative store identifier registry by using a backup store identifier that is different from the main store identifier. For example, the ME for one store/facility may use a primary store identifier transmitted at 1 Hz, whereas the backup store identifier may be transmitted at 1,000 Hz. The broadcast of the backup store identifier may need to be timed to occur during an interval in which the ESL's are scanning for wakeup packets. Since this normally coincides with the interview in which the primary store identifier is issued, there may need to be an overlap.

FIG. 4C is a process flow diagram illustrating a method 402 for onboarding an ESL performed by a processor and/or a transceiver of an ESL, in accordance with various embodiments. With reference to FIGS. 1A-4C, means for performing each of the operations of the method 400 may be performed by a processor (e.g., 210, 212, 214, 216, 218, 252, 260, and 602) and/or a transceiver (e.g., 604) of an ESL (e.g., 110) and the like.

In block 412, following the operations in block 406 of the method 400, the processor (e.g., 210, 212, 214, 216, 218, 252, 260) of the ESL (e.g., 110) may enter a low power mode (e.g., camping mode) in response to receiving the low power mode directive. For example, if the ESL was not recognized by the ME and/or the AP, the AP may be made to transmit the low power mode directive rather than onboarding that ESL so that the ESL may conserve power for later onboarding by an appropriate AP. In some embodiments, the ESL may enter the low power mode for a predetermined duration (e.g., 10 minutes). Alternatively, the ESL may enter the low power mode for a predetermined number of cycles (e.g., 10 cycles). As a further alternative, the ESL may enter a dormant mode for a predetermined duration and/or until otherwise activated (e.g., manual reset).

Additionally, in response to receiving the low power mode directive, the processor may store (i.e., save in memory) a store identifier (i.e., StoreID) associated with the wakeup packet in a negative store identifier registry. The negative store identifier registry may be used by the ESL to recognize foreign APs or APs that do not recognize that ESL. In this way, the ESL may use the negative store identifier registry as a filter to ignore wakeup packets from APs with store identifiers listed in the negative store identifier registry.

FIG. 4D is a process flow diagram illustrating a method 403 for onboarding an ESL performed by a processor and/or a transceiver of an ESL, in accordance with various embodiments. With reference to FIGS. 1A-4D, means for performing each of the operations of the method 400 may be performed by a processor (e.g., 210, 212, 214, 216, 218, 252, 260, and 602) and/or a transceiver (e.g., 604) of an ESL (e.g., 110) and the like.

In block 414, following the operations in block 412 of the method 402, the processor (e.g., 210, 212, 214, 216, 218, 252, 260) of the ESL (e.g., 110) may scan for a second wakeup packet from an access point remote from the ESL. The scan in block 412 for the second wakeup packet may follow the predetermined duration or number of cycles in the low power mode. Thus, after some time the ESL may be configured to once again scan for wakeup packets from an AP that recognizes the ESL. For example, the ESL may have been moved and is not within range of the appropriate AP.

In response to receiving a second wakeup packet, the ESL may examine the second wakeup packet to determine whether a store identifier included in the second wakeup packet matches any store identifiers saved in the negative store identifier registry, such as the store identifier associated with the first wakeup packet, which was saved in the negative store identifier registry.

In block 416, the processor may maintain the ESL in the low power mode in response to receiving a second wakeup packet including a store identifier that matches a negative store identifier registered from the received low power mode directive. For example, after being in the low power mode for a predetermined period or number of cycles, the ESL may still be within range of the same ESL that transmitted the lower power mode directive. By determining that the second wakeup packet is from an AP associated with the negative store identifier registry the ESL need not transmit advertising packets, but rather may maintain the low power mode.

FIG. 4E is a process flow diagram illustrating a method 404 for onboarding an ESL performed by a processor and/or a transceiver of an ESL, in accordance with various embodiments. With reference to FIGS. 1A-4E, means for performing each of the operations of the method 400 may be performed by a processor (e.g., 210, 212, 214, 216, 218, 252, 260, and 602) and/or a transceiver (e.g., 604) of an ESL (e.g., 110) and the like.

In block 418, following the operations in block 414 of the method 403, the processor (e.g., 210, 212, 214, 216, 218, 252, 260) of the ESL (e.g., 110) may enter a dormant mode in response to receiving a second wakeup packet including a store identifier that matches a negative store identifier registered from the received first wakeup packet. In this way, the ESL may conserve even more power after recognizing that it is still receiving wakeup packets from the same AP that previously directed it to enter low power mode. Alternatively, the ESL may maintain a counter so that it only enters the dormant mode after a predetermined number of scan cycles in which it receives a wakeup packet associated with a negative store identifier.

FIG. 4F is a process flow diagram illustrating a method 405 for onboarding an ESL performed by a processor and/or a transceiver of an ESL, in accordance with various embodiments. With reference to FIGS. 1A-4F, means for performing each of the operations of the method 400 may be performed by a processor (e.g., 210, 212, 214, 216, 218, 252, 260, and 602) and/or a transceiver (e.g., 604) of an ESL (e.g., 110) and the like.

In block 420, following the operations in block 414 of the method 403, the transceiver of the ESL may transmit the ESL advertisement in response to receiving a second wakeup packet that includes a store identifier override. The store identifier override may be configured to enable the ESL to ignore the negative store ID filter that would otherwise maintain the ESL in a low power mode or place the ESL in the dormant mode. The store identifier override may be as small as one bit included in a field of the wakeup packet, which when present tells the ESL to immediately transmit the ESL advertisement regardless of whether the transmitting AP is listed on the negative store identifier registry. The store identifier override may be used in cases were an ESL was prematurely activated or brought within range of an AP before that ESL was identified to the ME. ME's are generally given identifying information about individual ESLs (e.g., BD_ADDR) in order to allow the ME to establish secure communication with the ESL. Without the store identifier override, the ME may not have any easy way to get an ESL to send an advertising packet to an AP included on the negative store identifier registry.

In various embodiments the store management entity server, APs, or other entity may improve the battery life of ESLs by directing ESLs not being used (e.g., when no store picker or customer is near) to enter a low-latency (i.e., dormant) mode or scan-only mode and then selectively waking up subsets of those ESLs from that scan-only mode when needed (e.g., when a store picker or customer approaches those ESLs). In this way, when needed an AP may transmit a wakeup packet in an advertisement message that includes information that prompts receiving ESLs to enter a low-latency or scan-only mode to reduce energy consumption. Alternatively, the store management entity server, APs, or other entity may provide a schedule for when individual ESLs or groups of ESL should wakeup and/or transmit their advertising packets, which may also conserve energy.

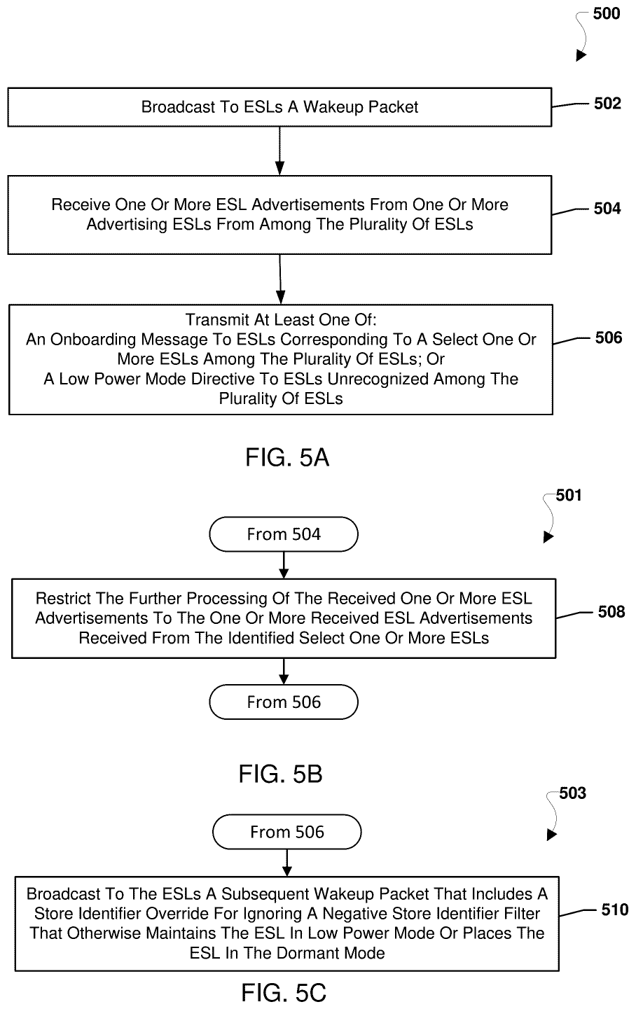

FIG. 5A is a process flow diagram illustrating a method 500 for onboarding an ESL performed by a processor and/or a transceiver of a computing device, in accordance with various embodiments. With reference to FIGS. 1A-5A, means for performing each of the operations of the method 500 may be performed by a processor (e.g., 210, 212, 214, 216, 218, 252, 260, and/or 801) and/or a transceiver (e.g., 717) of an AP (e.g., 110) and the like. Alternatively, the means for performing each of the operations of the method 500 may be performed by a processor (e.g., 210, 212, 214, 216, 218, 252, 260, 702, and/or 704) and/or a transceiver (e.g., 717) of a store management entity server (e.g., 150) and the like. As a further alternative, means for performing each of the operations of the method 500 may be performed by a processor of the AP and store management entity server or other computing device working in combination.

In block 502, the transmitter of the computing device may broadcast a wakeup packet for reception by ESLs. The wakeup packet may include information (e.g., identifiers, range of identifiers, ESL addresses, ranges of addresses, etc.) identify one or more ESLs from a plurality of ESLs that should transmit ESL advertisements. The AP may broadcast wakeup packets to numerous identified ESLs in order to make those ESLs switch from the scan-only mode to an advertising mode.

In various embodiments, the broadcasted wakeup packet may include a wakeup field that identifies the select one or more ESLs. For example, the broadcasted wakeup packet may include a wakeup field that identifies an address field of the select one or more ESLs. The broadcasted wakeup packet may include a range of values, which may be used to notify a range of ESL's to enter an advertising mode. For example, the range of values may indicate a value less than or equal to a sum of octets in an address field of the ESL. By designating a range of addresses, the ESL may assign groups of ESLs to advertise together. The size of such groups may be designed to ensure their simultaneous advertisements will not cause interference or too much interference and/or ensure proper performance of the AP.

In various embodiments, the broadcasted wakeup packet may include a wakeup field that includes a wildcard pattern, like “AA:BB:CC:DD:*.*.”, associated with the select one or more ESLs. Such a wildcard pattern parameter may be used to notify a subset of ESLs to wake up and start advertising.

In various embodiments, the broadcasted wakeup packet may include a wakeup field that includes at least one shelf or group identification associated with the select one or more ESLs. The select one or more ESLs may be identified as a subset of ESLs from the plurality of ESLs.

In various embodiments, the wakeup packet may indicate temporal restrictions when the select one or more ESLs should transmit the respective ESL advertisements. The temporal restrictions may include a time or an interval after which the ESL should enter the advertisement mode. Alternatively, or additionally, the temporal restrictions may indicate when the ESL should stop advertising and/or exit the advertising mode and return to the scan-only mode again. In this way, the wakeup packet may indicate a scan interval limiting when the select one or more ESLs should transmit the respective ESL advertisements.

In block 504, a processor of the computing device may receive one or more ESL advertisements from one or more ESLs from among the plurality of ESLs. In response to or as part of receiving the one or more ESL advertisements, the processor of the computing device may determine whether the received advertisements are from the appropriate ESL. In this way, the processor may determine whether the received advertisements correspond to ESLs to which the AP transmitted wakeup packets. In addition, the processor may determine whether the received advertisements from the ESLs are received at the appropriate time (e.g., not too early or too late). The wakeup packets may have indicated a precise window of time when the ESL advertising packets were supposed to have been transmitted. Thus, ESL advertising packets received outside the designated transmission window assigned to particular ESLs may be rejected (i.e., filtered out).

In block 506, the transceiver (e.g., 717) of the AP (e.g., 130), or the transceiver or network access ports (e.g., 804) of the store management entity server (e.g., 150), may transmit at least one of an onboarding message to ESLs corresponding to a select one or more ESLs among the plurality of ESLs or a low power mode directive to ESLs unrecognized among the plurality of ESLs. The onboarding information transmitted in block 506, in addition to establishing a communication link between the ESLs and the AP, may include all of the information that the ESL needs to display (e.g., product description, price, unit price, bar code, etc.) as well as information useful by the ESL processor performing various operations, such as entering a low power mode at various times to conserve power, a frequency or procedure for listening for further advertising messages from the AP, etc. Similarly, the low power mode directive may establish a communication link between select ESLs and the AP, which communication link may be used to cause the select ESLs to enter a low power mode (e.g., camping mode).

FIG. 5B is a process flow diagram illustrating a method 501 for onboarding an ESL performed by a processor and/or a transceiver of a computing device, in accordance with various embodiments. With reference to FIGS. 1A-5B, means for performing each of the operations of the method 501 may be performed by a processor (e.g., 210, 212, 214, 216, 218, 252, 260, and/or 801) and/or a transceiver (e.g., 717) of an AP (e.g., 110) and the like. Alternatively, the means for performing each of the operations of the method 501 may be performed by a processor (e.g., 210, 212, 214, 216, 218, 252, 260, 702, and/or 704) and/or a transceiver (e.g., 717) of a store management entity server (e.g., 150) and the like. As a further alternative, means for performing each of the operations of the method 501 may be performed by a processor of the AP and store management entity server or other computing device working in combination.

In block 508, following the operations in block 504 of the method 500, the processor of the computing device may restrict the further processing of the received one or more ESL advertisements to the one or more received ESL advertisements received from the identified select one or more ESLs. Thus, the processor of the computing device may restrict the further processing of ESL advertisements in response to determining that the received advertisements are not from the appropriate ESL. Additionally, or alternatively, the processor of the computing device may restrict the further processing of ESL advertisements in response to determining that the received advertisements are not received during the appropriate interval (e.g., the designated window of time). Following the operations in block 508, the processor may follow the operations in block 506 of the method 500.

In various embodiments, the AP may restrict further processing by protecting upper processing layers, such as above the host controller interface (HCI) layer, from too high a level of traffic or congestion, which could induce packet drops at the HCI (e.g., due to through put limitations). The HCI layer is generally a thin layer that transports commands and events between the host and controller elements of the BLE protocol stack. In this way the BLE Sub-system (e.g., the controller, below the HCI layer) may filter out unwanted advertisements collected by its radio and only supply the upper layers with the received ESL advertisements. Note that useful data (e.g., advertisements from ESLs or wanted targets) may be rarer than all other transmissions, which may imply that the probability of dropping wanted data will be much higher. In addition, unwanted packets may overload upper layers of the system, such as the Advanced Reduced Instruction Set Computer (RISC) Machines (a.k.a., Acorn RISC Machines) (ARM) type systems that run the BT stack and applications. Large delays may cause abnormal behavior in the system.

The BLE Sub-system (e.g., the controller, below the HCI layer) may filter out unwanted advertisements collected by its radio The BLE Sub-system (e.g., the controller, below the HCI layer) may filter out unwanted advertisements collected by its radio through the inspection of the ESL advertisement payload (e.g., searching for some specific Service IDs) or filtering on the basis of BD_ADDR (i.e., filtering out any BD_ADDR not from a specific vendor—or pre-allocated/expected BD_ADDR range for a given deployment). Whilst this filtering may not address spectral congestion, it may provide a helpful step to ensure that the HCI layer is not overwhelmed, which could lead to important packets being dropped.

FIG. 5C is a process flow diagram illustrating a method 502 for onboarding an ESL performed by a processor and/or a transceiver of a computing device, in accordance with various embodiments. With reference to FIGS. 1A-5C, means for performing each of the operations of the method 502 may be performed by a processor (e.g., 210, 212, 214, 216, 218, 252, 260, and/or 801) and/or a transceiver (e.g., 717) of an AP (e.g., 110) and the like. Alternatively, the means for performing each of the operations of the method 502 may be performed by a processor (e.g., 210, 212, 214, 216, 218, 252, 260, 702, and/or 704) and/or a transceiver (e.g., 717) of a store management entity server (e.g., 150) and the like. As a further alternative, means for performing each of the operations of the method 502 may be performed by a processor of the AP and store management entity server or other computing device working in combination.

In block 510, following the operations in block 506 of the method 500, the processor of the computing device may broadcast to the ESLs a second wakeup packet that includes a store identifier override for ignoring a negative store identifier filter that otherwise maintains the ESL in low power mode or places the ESL in the dormant mode.

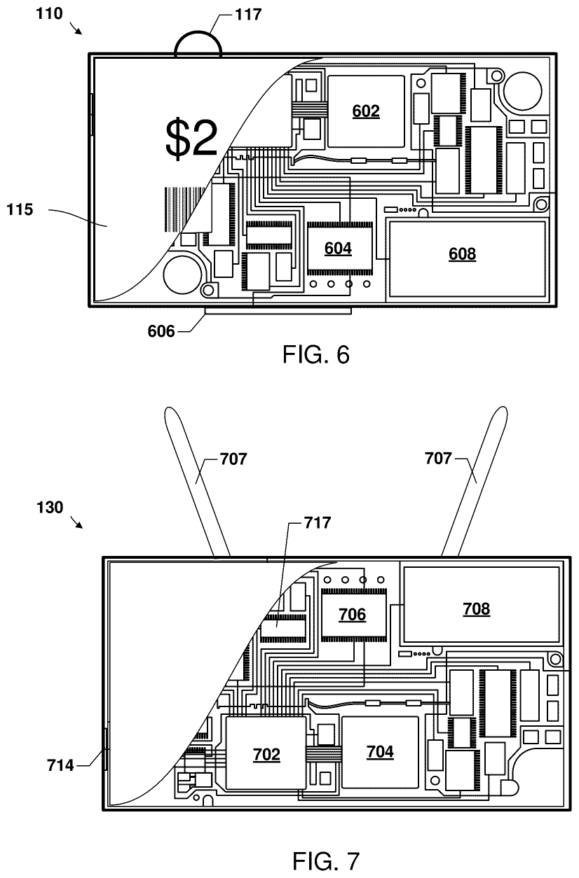

FIG. 6 is a component block diagram of an example of an ESL 110 suitable for use with various embodiments. With reference to FIGS. 1A-6, an ESL 110 may include a display 115 and an LED 117 (or other type of visible indicator) that our coupled to a processor 602 that is configured with processor-executable instructions configured to cause the processor to perform operations of various embodiments. The processor 602 may be coupled to a wireless transceiver 604, such as a BLE transceiver or a combination BLE and Wi-Fi transceiver, that is coupled to an antenna 606 for sending and receiving RF signals as described herein. In various embodiments, the processor 602 may include an SOC (e.g., 202, 204). An ESL 110 may be powered by a battery 608, freeing the display from having to be connected to a wired power supply. Alternatively, the ESL 110 may be powered from an external source.

FIG. 7 is a component block diagram of an AP 130 suitable for use with various embodiments. With reference to FIGS. 1A-7, the AP 130 may typically include a processor 702, 704 coupled to volatile memory 706 and optionally a larger capacity nonvolatile memory 708. The AP 130 may also include a peripheral memory access device, such as a flash drive, coupled to the processor 702, 704. The AP 130 may also include network access ports 714 (or interfaces) coupled to the processor 702, 704 for establishing data connections with a network, such as the Internet and/or a local area network coupled to other system computers and servers. The AP 130 may include additional access ports, such as USB, Firewire, Thunderbolt, and the like for coupling to peripherals, external memory, or other devices. The AP 130 may include one or more antennas 707 coupled to a transceiver 717 for sending (i.e., transmitting) and receiving electromagnetic radiation that may be connected to a wireless communication link.

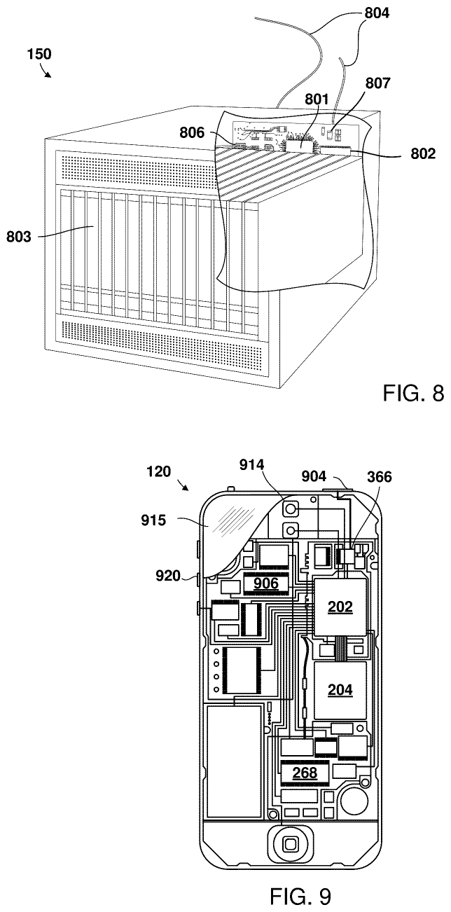

FIG. 8 is a component block diagram of a store management entity server 150 suitable for use with various embodiments. With reference to FIGS. 1A-8, the store management entity server 150 may typically include a processor 801 coupled to volatile memory 802 and a large capacity nonvolatile memory, such as a disk drive 803. The store management entity server 150 may also include a peripheral memory access device, such as a floppy disc drive, compact disc (CD) or digital video disc (DVD) drive 806 coupled to the processor 801. The store management entity server 150 may also include network access ports 804 (or interfaces) coupled to the processor 801 for establishing data connections with a network, such as the Internet and/or a local area network coupled to other system computers and servers. The store management entity server 150 may include one or more antennas 807 for sending and receiving electromagnetic radiation that may be connected to a wireless communication link. The store management entity server 150 may include additional access ports, such as USB, Firewire, Thunderbolt, and the like for coupling to peripherals, external memory, or other devices.

FIG. 9 is a component block diagram of a user mobile device 120 suitable for use as a user mobile device or a consumer user equipment (UE) when configured with processor executable instructions to perform operations of various embodiments. With reference to FIGS. 1A-9, the user mobile device 120 may include a first SOC 202 (e.g., a SOC-CPU) coupled to a second SOC 204 (e.g., a 5G capable SOC). The first and second SOCs 202, 204 may be coupled to internal memory 906, a display 915, and to a speaker 914. Additionally, the user mobile device 120 may include an antenna 904 for sending and receiving electromagnetic radiation that may be connected to a radio module 266 configured to support wireless local area network data links (e.g., BLE, Wi-Fi, etc.) and/or wireless wide area networks (e.g., cellular telephone networks) coupled to one or more processors in the first and/or second SOCs 202, 204. The user mobile device 120 typically also include menu selection buttons 920 for receiving user inputs.

A typical user mobile device 120 may also include an inertial measurement unit (IMU) 268 that includes a number of micro-electromechanical sensor (MEMS) elements configured to sense accelerations and rotations associated movements of the device, and provide such movement information to the first SOC 202. Also, one or more of the processors in the first and second SOCs 202, 204, wireless transceiver 266 may include a digital signal processor (DSP) circuit (not shown separately).

In some embodiments, a user mobile device 120 may be used as a moving AP to diagnose ESLs that have issues establishing communication with the APs or other fixed infrastructure. For example, the user mobile device 120 may be repurposed by the store management entity server by configuring the user mobile device 120 with AP protocols so that the user mobile device 120 may be recognized by ESL as an AP.

The processors of ESLs 110, the user mobile device 120, and the store management entity server 150 may be any programmable microprocessor, microcomputer or multiple processor chip or chips that can be configured by software instructions (applications) to perform a variety of functions, including the functions of the various embodiments described below. In some user mobile devices, multiple processors may be provided, such as one processor within an SOC 204 dedicated to wireless communication functions and one processor within an SOC 202 dedicated to running other applications. Typically, software applications may be stored in the memory 906 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400, 401, and/or 500 may be substituted for or combined with one or more operations of the methods 400, 401, and/or 500.

Implementation examples are described in the following paragraphs. While some of the following implementation examples are described in terms of example methods, further example implementations may include: the example methods discussed in the following paragraphs implemented by an ESL, an AP, a store management entity server (or other entity), and/or a user mobile device, including a processor configured to perform operations of the example methods; the example methods discussed in the following paragraphs implemented by an ESL, an AP, a store management entity server (or other entity), and/or a user mobile device, including means for performing functions of the example methods; the example methods discussed in the following paragraphs implemented in a processor used in an ESL, an AP, a store management entity server (or other entity), and/or a user mobile device that is configured to perform the operations of the example methods; and the example methods discussed in the following paragraphs implemented as a non-transitory processor-readable storage medium having stored thereon processor-executable instructions configured to cause a processor or modem processor to perform the operations of the example methods.

Example 1. A method for receiving onboarding information in an electronic shelf label (ESL), including: scanning, by a processor of the ESL, for a wakeup packet from an access point remote from the ESL before transmitting an ESL advertisement; transmitting, by a transmitter of the ESL, the ESL advertisement in response to receiving a first wakeup packet that includes information indicating the ESL should transmit the ESL advertisement; and receiving onboarding messages or a low power mode directive from the access point.

Example 2. The method of example 1, in which the information indicating the ESL should transmit the ESL advertisement includes an identification associated with the ESL.

Example 3. The method of either of examples 1 or 2, in which the information indicating the ESL should transmit the ESL advertisement includes a value associated with an address field of the ESL.

Example 4. The method of any of examples 1-3, in which the information indicating the ESL should transmit the ESL advertisement includes at least one of a value less than or equal to a sum of octets in an address field of the ESL; a wildcard pattern parameter; or a matching value associated with a shelf identification associated with the ESL.

Example 5. The method of any of examples 1-4, in which transmitting the ESL advertisement is timed by the ESL in accordance with an advertising interval included in the received wakeup packet.

Example 6. The method of any of examples 1-5, in which transmitting the ESL advertisement is delayed to conform with a scan interval indicated in the received first wakeup packet.

Example 7. The method of any of examples 1-6, further including ceasing transmission of the ESL advertisement in accordance with an advertisement timeout label included in the received wakeup packet.

Example 8. The method of any of examples 1-7, further including entering a low power mode in response to receiving the low power mode directive.

Example 9. The method of example 8, further including maintaining the low power mode in response to receiving a second wakeup packet including a store identifier that matches a negative store identifier registered from the received low power mode directive.

Example 10. A method for onboarding an electronic shelf label (ESL) among a plurality of ESLs, including broadcasting, by a transmitter of a computing device to an ESL, a wakeup packet; receiving, by a processor of the computing device, one or more ESL advertisements from the identified select one or more advertising ESLs from among the plurality of ESLs; and transmitting, by the transmitter of the computing device, at least one of an onboarding message to ESLs corresponding to a select one or more ESLs among the plurality of ESLs; or a low power mode directive to ESLs unrecognized among the plurality of ESLs.

Example 11. The method of example 10, further including restricting further processing, by the processor of the computing device, of received one or more ESL advertisements to one or more ESL advertisements received from the identified select one or more ESLs.

Example 12. The method of either of examples 10 or 11, in which the broadcasted wakeup packet includes a wakeup field that identifies the select one or more ESLs.

Example 13. The method of any one of examples 10-12, in which the broadcasted wakeup packet includes a wakeup field that includes a value less than or equal to a sum of octets in an address field of the select one or more ESLs.

Example 14. The method of any one of examples 10-13, in which the broadcasted wakeup packet includes a wakeup field that includes a wildcard pattern associated with the select one or more ESLs.

Example 15. The method of any one of examples 10-14, in which the broadcasted wakeup packet includes a wakeup field that includes at least one shelf identification associated with the select one or more ESLs.

Example 16. The method of any one of examples 10-15, in which the broadcasted wake up packet identifies the select one or more ESLs as a subset of ESLs from the plurality of ESLs.

Example 17. The method of any one of examples 10-16, in which the broadcasted wakeup packet indicates temporal restrictions when the select one or more ESLs should transmit the respective ESL advertisements.

Example 18. The method of any one of examples 10-17, in which the broadcasted wakeup packet indicates a scan interval limiting when the select one or more ESLs should transmit the respective ESL advertisements.

Example 19. The method of any one of examples 10-18, in which the broadcasted wakeup packet includes more than one distinct wakeup field for identifying the select one or more ESLs.

Example 20. The method of any one of examples 10-19, further comprising broadcasting to the ESLs a second wakeup packet that includes a store identifier override for ignoring a negative store identifier filter that otherwise maintains the ESL in low power mode or places the ESL in the dormant mode.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iDEN), C-V2X, V2V, V2P, V2I, and V2N, etc. Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, 7PROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for receiving onboarding information in an electronic shelf label (ESL), comprising:
scanning, by a processor of the ESL, for a wakeup packet from an access point remote from the ESL before transmitting an ESL advertisement;
transmitting, by a transmitter of the ESL, the ESL advertisement in response to receiving a first wakeup packet that includes information indicating the ESL should transmit the ESL advertisement; and
receiving onboarding messages or a low power mode directive from the access point.

2. The method of claim 1, wherein the information indicating the ESL should transmit the ESL advertisement includes an identification associated with a limited number of ESLs.

3. The method of claim 1, wherein the information indicating the ESL should transmit the ESL advertisement includes a value associated with an address field of the ESL.

4. The method of claim 1, wherein the information indicating the ESL should transmit the ESL advertisement includes at least one of:
a value less than or equal to a sum of octets in an address field of the ESL;
a wildcard pattern parameter; or
a matching value associated with a shelf identification associated with the ESL.

5. The method of claim 1, wherein transmitting the ESL advertisement is timed by the ESL in accordance with an advertising interval included in the received wakeup packet.

6. The method of claim 1, wherein transmitting the ESL advertisement is delayed to conform with a scan interval indicated in the received first wakeup packet.

7. The method of claim 1, further comprising:
ceasing transmission of the ESL advertisement in accordance with an advertisement timeout label included in the received wakeup packet.

8. The method of claim 1, further comprising:
entering a low power mode in response to receiving the low power mode directive.

9. The method of claim 8, further comprising:
maintaining the low power mode in response to receiving a second wakeup packet including a store identifier that matches a negative store identifier registered from the received low power mode directive.

10. An electronic shelf label (ESL), comprising:
a transceiver; and
a processor coupled to the transceiver and configured to:
scan for a wakeup packet from an access point remote from the ESL before transmitting an ESL advertisement;
transmit, using the transceiver, the ESL advertisement in response to receiving a first wakeup packet that includes information indicating the ESL should transmit the ESL advertisement; and
receive onboarding messages or a low power mode directive from the access point.

11. The ESL of claim 10, wherein the processor is configured such that the information indicating the ESL should transmit the ESL advertisement includes an identification associated with the ESL.

12. The ESL of claim 10, wherein the processor is configured such that the information indicating the ESL should transmit the ESL advertisement includes a value associated with an address field of the ESL.

13. The ESL of claim 10, wherein the processor is configured such that the information indicating the ESL should transmit the ESL advertisement includes at least one of:
a value less than or equal to a sum of octets in an address field of the ESL;
a wildcard pattern parameter; or
a matching value associated with a shelf identification associated with the ESL.

14. The ESL of claim 10, wherein the processor is configured such that transmitting the ESL advertisement is timed by the ESL in accordance with an advertising interval included in the received wakeup packet.

15. The ESL of claim 10, wherein the processor is configured such that transmitting the ESL advertisement is delayed to conform with a scan interval indicated in the received first wakeup packet.

16. The ESL of claim 10, wherein the processor is further configured to cease transmission of the ESL advertisement in accordance with an advertisement timeout label included in the received wakeup packet.

17. The ESL of claim 10, wherein the processor is further configured to enter a low power mode in response to the low power mode directive.

18. The ESL of claim 17, wherein the processor is further configured to maintain the low power mode in response to receiving a second wakeup packet including a store identifier that matches a negative store identifier registered from the received low power mode directive.

19. A method for onboarding an electronic shelf label (ESL) among a plurality of ESLs, comprising:
broadcasting, by a transmitter of a computing device to an ESL, a wakeup packet;
receiving, by a processor of the computing device, one or more ESL advertisements from the identified select one or more advertising ESLs from among the plurality of ESLs; and
transmitting, by the transmitter of the computing device, at least one of:
an onboarding message to ESLs corresponding to a select one or more ESLs among the plurality of ESLs; or
a low power mode directive to ESLs unrecognized among the plurality of ESLs.

20. The method of claim 19, further comprising:
restricting further processing, by the processor of the computing device, of received one or more ESL advertisements to one or more received ESL advertisements received from the identified select one or more ESLs.

21. The method of claim 19, wherein the broadcasted wakeup packet includes a wakeup field that identifies the select one or more ESLs.

22. The method of claim 19, wherein the broadcasted wakeup packet includes a wakeup field that includes a value less than or equal to a sum of octets in an address field of the select one or more ESLs.

23. The method of claim 19, wherein the broadcasted wakeup packet includes a wakeup field that includes a wildcard pattern associated with the select one or more ESLs.

24. The method of claim 19, wherein the broadcasted wakeup packet includes a wakeup field that includes at least one shelf identification associated with the select one or more ESLs.

25. The method of claim 19, wherein the broadcasted wakeup packet identifies the select one or more ESLs as a subset of ESLs from the plurality of ESLs.

26. The method of claim 19, wherein the broadcasted wakeup packet indicates temporal restrictions when the select one or more ESLs should transmit the respective ESL advertisements.

27. The method of claim 19, wherein the broadcasted wakeup packet indicates a scan interval limiting when the select one or more ESLs should transmit the respective ESL advertisements.

28. The method of claim 19, wherein the broadcasted wakeup packet includes more than one distinct wakeup field for identifying the select one or more ESLs.

29. The method of claim 19, further comprising:
broadcasting to the ESLs a second wakeup packet that includes a store identifier override for ignoring a negative store identifier filter that otherwise maintains the ESL in low power mode or places the ESL in the dormant mode.

30. An access point (AP), comprising:
a transceiver; and
a processor coupled to the transceiver and configured to:
broadcast, using the transceiver, a wakeup packet;
receive one or more ESL advertisements from the identified select one or more advertising ESLs from among a plurality of ESLs; and
transmit, using the transceiver, at least one of:
an onboarding message to ESLs corresponding to a select one or more ESLs among the plurality of ESLs; or
a low power mode directive to ESLs unrecognized among the plurality of ESLs.

31. The AP of claim 30, wherein the processor is further configured to:
restrict further processing of received one or more ESL advertisements to one or more ESL advertisements received from the identified select one or more ESLs.

32. The AP of claim 30, wherein the processor is configured such that the broadcasted wakeup packet includes a wakeup field that identifies the select one or more ESLs.

33. The AP of claim 30, wherein the processor is configured such that the broadcasted wakeup packet includes a wakeup field that includes a value less than or equal to a sum of octets in an address field of the select one or more ESLs.

34. The AP of claim 30, wherein the processor is configured such that the broadcasted wakeup packet includes a wakeup field that includes a wildcard pattern associated with the select one or more ESLs.

35. The AP of claim 30, wherein the processor is configured such that the broadcasted wakeup packet includes a wakeup field that includes at least one shelf identification associated with the select one or more ESLs.

36. The AP of claim 30, wherein the processor is configured such that the broadcasted wake up packet identifies the select one or more ESLs as a subset of ESLs from the plurality of ESLs.

37. The AP of claim 30, wherein the processor is configured such that the broadcasted wakeup packet indicates temporal restrictions when the select one or more ESLs should transmit the respective ESL advertisements.

38. The AP of claim 30, wherein the processor is configured such that the broadcasted wakeup packet indicates a scan interval limiting when the select one or more ESLs should transmit the respective ESL advertisements.

39. The AP of claim 30, wherein the processor is configured such that the broadcasted wakeup packet includes more than one distinct wakeup field for identifying the select one or more ESLs.

40. The AP of claim 30, wherein the processor is further configured to broadcast to the ESLs a second wakeup packet that includes a store identifier override for ignoring a negative store identifier filter that otherwise maintains the ESL in low power mode or places the ESL in the dormant mode.
